(19) United States
(12) Patent Application Publication
(10) Pub. No.: US 2003/0158890 A1
(43) Pub. Date: Aug. 21, 2003

(54) Channel communication mechanism

(76) Inventors: Layne B. Miller, Campbell, CA (US); Robert J. Petri, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/062,682

(22) Filed: Jan. 31, 2002

(51) Int. Cl. G06F 15/16

(52) U.S. Cl. 709/203; 709/245; 709/213

(57) ABSTRACT

A mechanism for communication between a first software application and a second software application. A channel receives from a first software application transport information and an identifier of a memory location of a message to a second software application. The channel stores in a different memory location the transport information and the identifier of the memory location of the message. The channel transmits to the second software application based on the transport information a different identifier of the different memory location. The channel receives the different identifier of the different memory location from the second software application. The channel retrieves from the different memory location the identifier of the memory location and transmits the identifier of the memory location to the second software application.

### FIELD OF THE INVENTION

The present invention relates to a communication mechanism. More particularly, the invention relates to a mechanism for communication between a client software application and a server software application.

### BACKGROUND OF THE INVENTION

Internet Exchange Architecture (IXA) developed by Intel Corporation of Santa Clara, Calif., is a packet-processing architecture for use with computer networks such as the Internet. A network is a group of two or more network devices linked together. A network device is an electronic system, such as a desktop computer, a personal digital assistant, a mobile or laptop computer, a cellular or mobile telephone, etc., that is accessible by or over a network. A packet is the unit of data that is routed between an origination network device and a destination network device based on the destination address contained within the packet.

With IXA, a packet that enters a network device is processed by action classification engines (ACEs). ACEs transport the packet from one ACE to another for processing until the packet exits the network device. ACEs process packets in two phases: a classification phase, which involves identifying a packet, and an action phase, which involves performing tasks based on the packet's classification.

An IXA software development kit (SDK) provides tools for writing software applications that use ACEs to process packets. A software application is a set of instructions that an electronic system follows to perform a task. In the IXA SDK environment, one software application known as a client accesses two other software applications, known as services, that perform ACE-related tasks: the resolver, which creates ACEs, and the name server, which tracks the names and locations of the ACEs running in a network device. A client is a software application that obtains data from a server software application. A server is a software application that provides a specific type of service to a client. A service is work performed by a server, for example, providing data in response to a request for data.

In order to use a service, for example, to request the name of an ACE from the name server, a client must be able to communicate with the service. A client may contain a set of instructions as a mechanism for communicating with a service. Typically, the mechanism one client uses to communicate with a service is similar to the mechanism other clients use to communicate with a service. It is unnecessarily redundant for each client to contain its own mechanism for communicating with a service.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of an electronic system.

FIGS. 2A and 2B are a flow diagram illustrating one embodiment of establishing a connection between a client software application and a server software application.

FIG. 3 is a flow diagram illustrating one embodiment of a client software application using a channel to transmit a message to a server software application.

FIGS. 4A and 4B are a flow diagram illustrating one embodiment of a server software application using a channel to receive and reply to a message from a client software application.

FIG. 5 is a flow diagram illustrating one embodiment of a client software application using a channel to receive a reply from a server software application.

FIG. 6 is a block diagram of one embodiment of a client software application using a channel to establish a connection with a server software application.

FIG. 7 is a block diagram of one embodiment of a client software application using a channel to transmit a message to a server software application.

FIG. 8 is a flow diagram illustrating one embodiment of closing a channel.

FIG. 9 is a block diagram of one embodiment of a client software application closing a channel.

### DETAILED DESCRIPTION

A mechanism for communication between a client software application and a server software application is described. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

A mechanism for communication between a client software application (referred to herein as a client) and a server software application (referred to herein as a server) is described. A client requires information from a service, e.g., a name server or a resolver, performing tasks as part of a server. As a result, the client and server create a channel. A channel is a connection used for communication and message transmission between the client and the server.

In order to create a channel, the client transmits a message to the server requesting that the server establish a channel with the client. Along with the message, the client transmits an identifier of a location at which the server can receive request messages from the client and an identifier of a location to which the server can transmit reply messages to the client. The server transmits a reply notifying the client that the server will establish the channel.

The client and the server establish their respective components of the channel. The channel contains four complimentary components: the client-side outgoing component of the channel (CSO) and the client-side incoming component of the channel (CSI), which exist in the client, and the server-side incoming component of the channel (SSI) and the server-side outgoing component (SSO) of the channel, which exist in the server.

Using the channel, the client transmits messages to the server, and the server transmits replies to the client. The first component of the channel, the CSO, receives an identifier of a location of a message from the client. The CSO stores the identifier in an envelope and transmits an identifier of the location of the envelope to the client, which transmits the identifier to the second component of the channel, i.e., the SSI. The SSI receives the identifier of the location of the envelope, extracts the identifier of the location of the message from the envelope and transports the identifier of the location of the message to the server. The server retrieves the message and transmits the message to a service performing tasks as part of the server.

The service generates a reply to the message. The server retrieves the reply, stores the reply and transmits an identifier of the location of the reply to the third component of the channel, i.e., the SSO. The SSO stores the identifier of the location of the reply in a reply envelope and transmits an identifier of the location of the reply envelope to the client, which transmits the identifier of the location of the reply envelope to the fourth component of the channel, i.e., the CSI. The CSI receives the identifier of the location of the reply envelope and extracts the identifier of the location the reply from the reply envelope. The CSI transmits to the client the identifier of the location of the reply, and the client retrieves the reply. Once the client and server have completed communicating via the channel, the client and server close the channel.

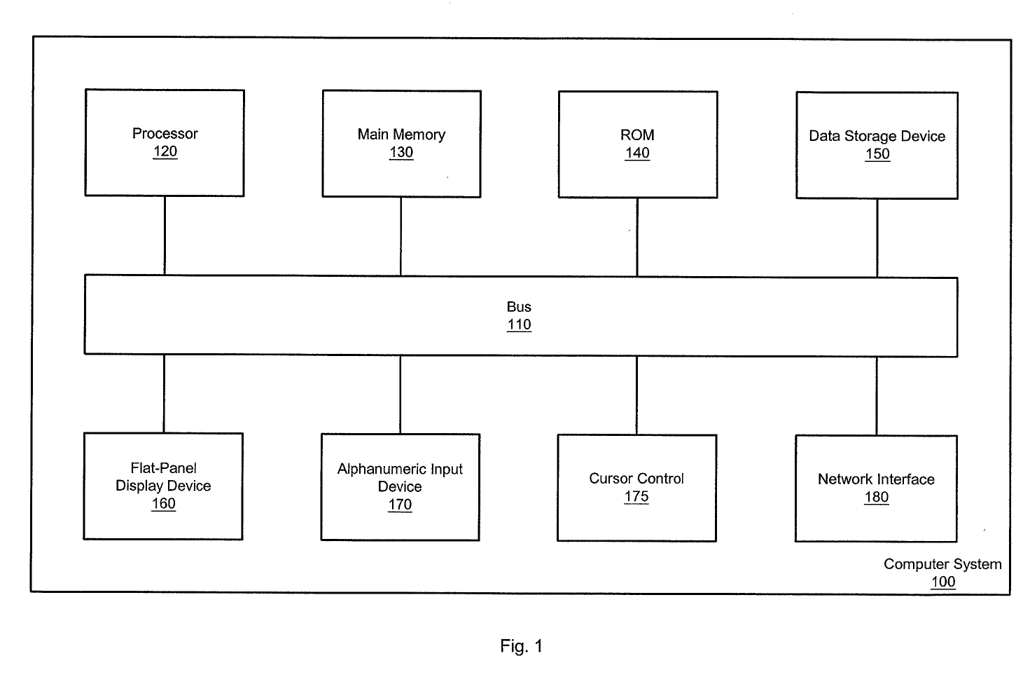

FIG. 1 is a block diagram of one embodiment of an electronic system. In one embodiment, the mechanism described herein can be implemented as sequences of instructions executed by an electronic system. The sequences of instructions can be stored by the electronic system. In addition, the instructions can be received by the electronic system (e.g., via a network connection). The electronic system is intended to represent a range of electronic systems, including, for example, a personal digital assistant (PDA), a laptop or palmtop computer, a cellular phone, a network access device, etc. Other electronic systems can include more, fewer and/or different components.

Electronic system 100 includes a bus 110 or other communication device to communicate information, and processor 120 coupled to bus 110 to process information. While electronic system 100 is illustrated with a single processor, electronic system 100 can include multiple processors and/or co-processors.

Electronic system 100 further includes random access memory (RAM) or other dynamic storage device 130 (referred to as memory), coupled to bus 110 to store information and instructions to be executed by processor 120. Memory 130 also can be used to store temporary variables or other intermediate information while processor 120 is executing instructions. Electronic system 100 also includes read-only memory (ROM) and/or other static storage device 140 coupled to bus 110 to store static information and instructions for processor 120. In addition, data storage device 150 is coupled to bus 110 to store information and instructions. Data storage device 150 may comprise a magnetic disk (e.g., a hard disk) or optical disc (e.g., a CD-ROM) and corresponding drive.

Electronic system 100 may further comprise a display device 160, such as a cathode ray tube (CRT) or liquid crystal display (LCD), to display information to a user. Alphanumeric input device 170, including alphanumeric and other keys, is typically coupled to bus 110 to communicate information and command selections to processor 120. Another type of user input device is cursor control 175, such as a mouse, a trackball, or cursor direction keys to communicate direction information and command selections to processor 120 and to control cursor movement on display device 160. Electronic system 100 further includes network interface 180 to provide access to a network, such as a local area network.

Instructions are provided to memory from a machine-accessible medium, or an external storage device accessible via a remote connection (e.g., over a network via network interface 180) providing access to one or more electronically-accessible media, etc. A machine-accessible medium includes any mechanism that provides (i.e., stores and/or transmits) information in a form readable by a machine (e.g., a computer). For example, a machine-accessible medium includes RAM; ROM; magnetic or optical storage medium; flash memory devices; electrical, optical, acoustical or other form of propagated signals (e.g., carrier waves, infrared signals, digital signals); etc.

In alternative embodiments, hard-wired circuitry can be used in place of or in combination with software instructions to implement the present invention. Thus, the present invention is not limited to any specific combination of hardware circuitry and software instructions.

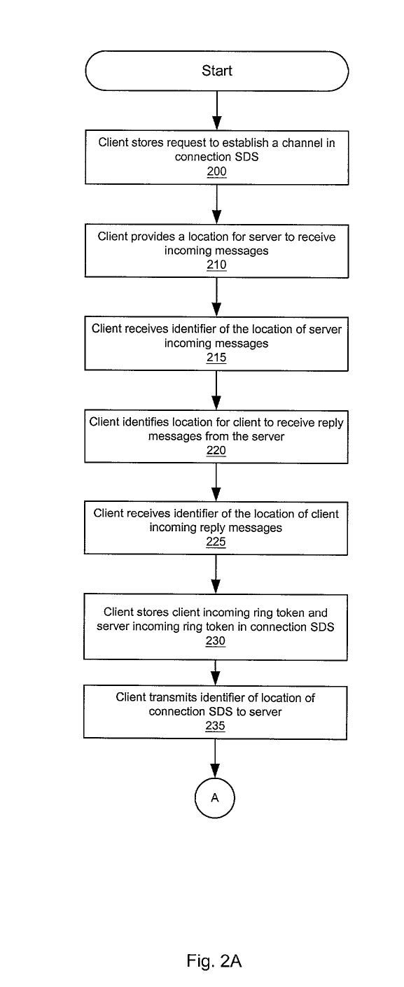

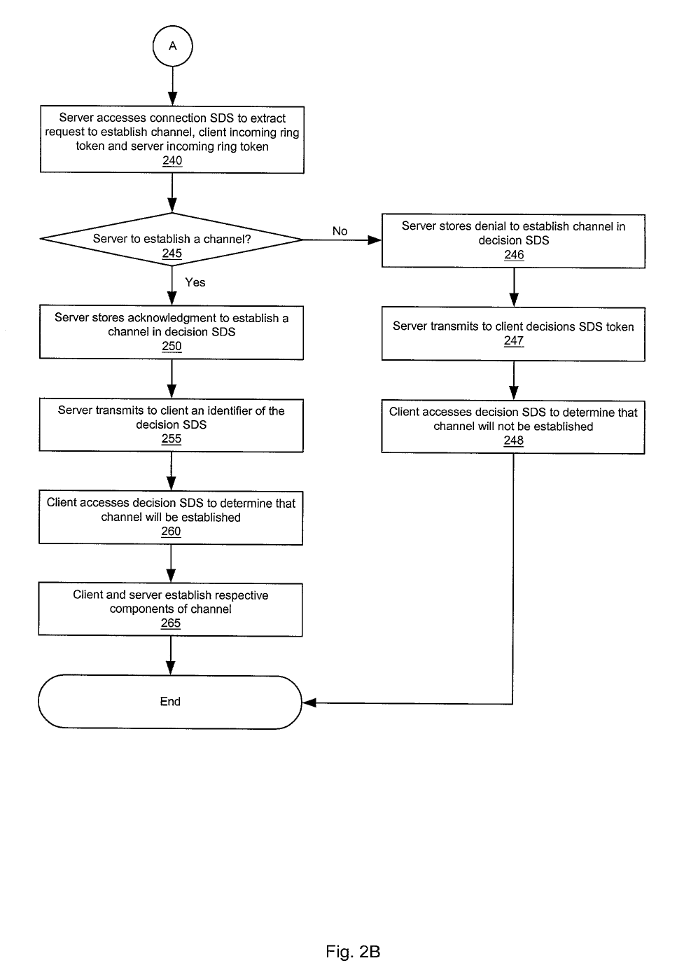

FIGS. 2A and 2B are a flow diagram illustrating one embodiment of establishing a channel between a client and a server. The channel mechanism is described in terms of IXA SDK components. However, the channel mechanism is not limited to use with IXA SDK components. The channel mechanism can be implemented with components that function in the same manner as the IDX SDK components described herein, or with other types of channel management components.

For purposes of illustration and ease of explanation, the figures described in this Detailed Description section of this application will be described in specific terms of a serialized data stream as a storage location. A serialized data stream (SDS) is a block of shared memory where data can be stored or extracted by an entity directed to the location of the data. However, other storage locations can be used. For purposes of illustration and ease of explanation, the figures described in this Detailed Description section of this application will be described in specific terms of a ring as a data deposit location. A ring is a message queue. However, other data deposit locations can be used. For purposes of illustration and ease of explanation, the figures described in this Detailed Description section of this application will be described in specific terms of a token as an identifier. A token is an identifier that points to that which the token identifies. However, other identifiers can be used.

A client requires information from a service performing tasks as part of a server. At 200 in FIG. 2A, the client stores a request to establish a channel between the client and the server. A channel is a connection used for communication and message transmission between the client and the server. In one embodiment, the client allocates a connection SDS and stores a connection request in the connection SDS.

At 210, the client allocates a location that the server will use to receive incoming messages from the client. In one embodiment, the client allocates a new ring (the server incoming ring) which the server will use to receive incoming request messages from the client. At 215, as a result of allocating the server incoming ring, the client receives an identifier for the server incoming ring. In one embodiment, the client receives a token for the server incoming ring.

At 220, the client identifies a location at which the client will receive reply messages from the server. In one embodiment, the client identifies an existing ring (the client incoming ring) that is part of the client's cap as the location at which the client will receiver reply messages from the server. A cap is a known way for servers to communicate with the client. At 225, the client receives an identifier for the client incoming ring. In one embodiment, the client receives a token for the client incoming ring.

At 230, the client stores the server incoming ring token and the client incoming ring token in the connection SDS with the request to establish the channel. At 235, the client transmits to the server an identifier of the location of the connection SDS. In one embodiment, the client transmits a connection SDS token to the central ring of the server. The central ring of the server is a ring which clients know to use to contact the server. In alternative embodiments, the token can be transmitted to other locations. At 240 in FIG. 2B, the server accesses the connection SDS in order to extract the request to establish the channel, the server incoming ring token and the client incoming ring token.

At 245, a determination is made whether the server will establish the channel. When the channel is to be established, at 250 the server stores an acknowledgement to establish the channel. In one embodiment, the server allocates a decision SDS and stores the acknowledgement in the decision SDS. At 255, the server transmits to the client an identifier of the decision SDS. In one embodiment, the server transmits a decision SDS token to the client incoming ring.

At 260, the client accesses the decision SDS in order to determine that the channel will be established. At 265, the client and the server establish their respective components of the channel. That is, the client establishes the CSO and the CSI, and the server establishes the SSO and the SSI.

When at 245 the channel will not be established, at 246 the client stores in the decisions SDS a denial to establish the channel. At 247, the server transmits to the client a decision SDS token. At 248, the client accesses the decisions SDS in order to determine that the channel will not be established, and the interaction between the client and server ends.

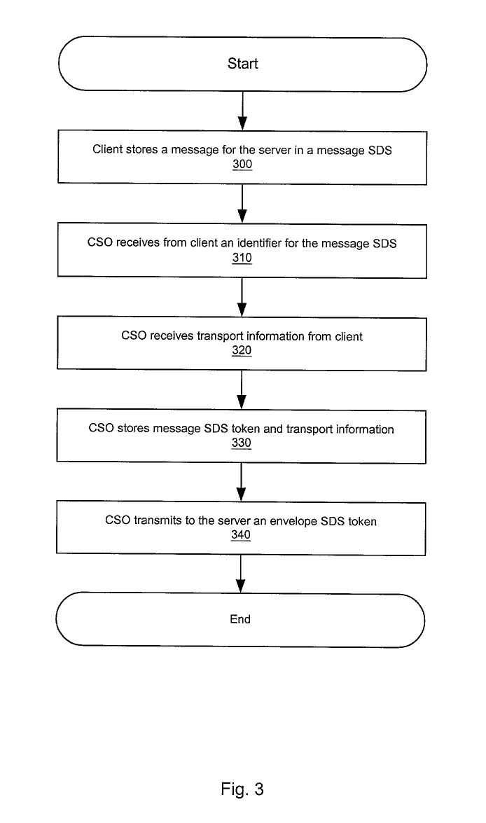

FIG. 3 is a flow diagram illustrating one embodiment of a client using a channel to transmit a message to a server. At 300, the client stores a message, e.g., requesting certain data, for the server. In one embodiment, the client allocates a message SDS and stores the message in the message SDS. At 310, the CSO receives from the client an identifier for the message SDS. In one embodiment, the client transmits a message SDS token to the CSO.

At 320, the CSO receives transport information from the client, in order to enable the CSO to determine the server for which the message is intended. In one embodiment, the transport information consists of a token for the CSI; a token for the message in the message SDS so that the CSO can keep track of the message; and an indicator for the amount of time the channel is to wait for a reply from the server. In alternative embodiments, the transport information can consist of additional or less information.

At 330, the CSO stores the message SDS token and the transport information. In one embodiment, the client allocates an envelope SDS and stores the message SDS token and transport information in the envelope SDS. At 340, the CSO transmits to the server an identifier for the envelope SDS. In one embodiment, the CSO transmits an envelope SDS token to the server incoming ring.

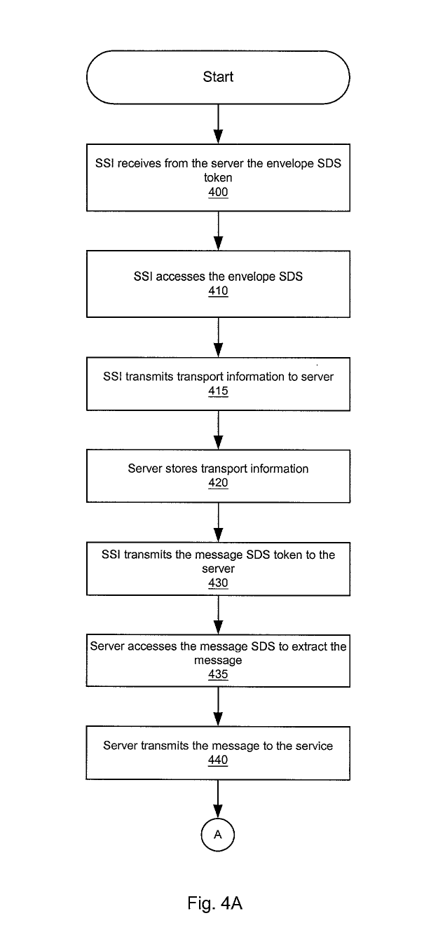

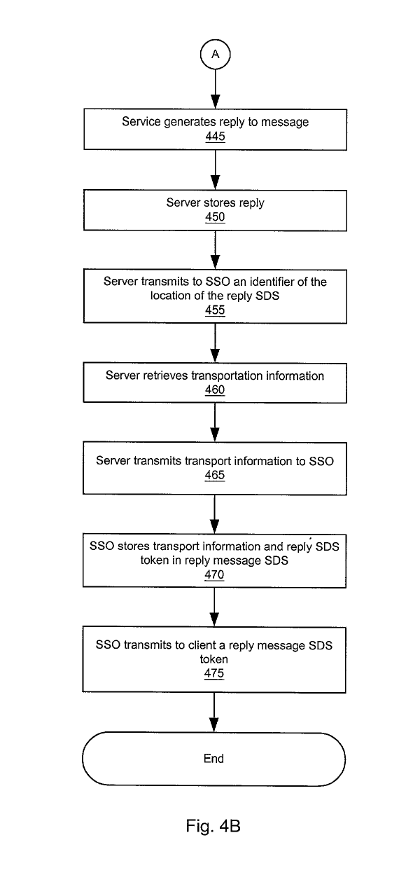

FIGS. 4A and 4B are a flow diagram illustrating one embodiment of a server using a channel to receive and reply to a message received from a client. At 400 in FIG. 4A, the SSI receives from the server the envelope SDS token. At 410, the SSI accesses the envelope SDS. At 415, the SSI transmits the transport information to the server. At 420, the server stores the transport information for subsequent retrieval in order to provide to the SSO the location of the client that is to receive the reply. At 430, the SSI transmits to the server the message SDS token.

At 435, the server accesses the message SDS in order to extract the message. At 440, the server transmits the message to the service. At 445 in FIG. 4B, the service generates a reply to the message. At 450, the server stores the reply. In one embodiment, the server allocates a reply SDS and stores the reply in the reply SDS. At 455, the server transmits an identifier for the reply SDS to the SSO. In one embodiment, the server transmits a reply SDS token to the SSO. At 460, the server retrieves the transport information, and at 465 transmits the transport information to the SSO.

At 470, the SSO stores the reply SDS token and the transportation information. In one embodiment, the SSO allocates a reply message SDS and stores the transport information and the reply SDS token in the reply message SDS. At 475, the SSO transmits to the client an identifier for the reply message SDS. In one embodiment, the SSO transmits a reply message SDS token to the client incoming ring.

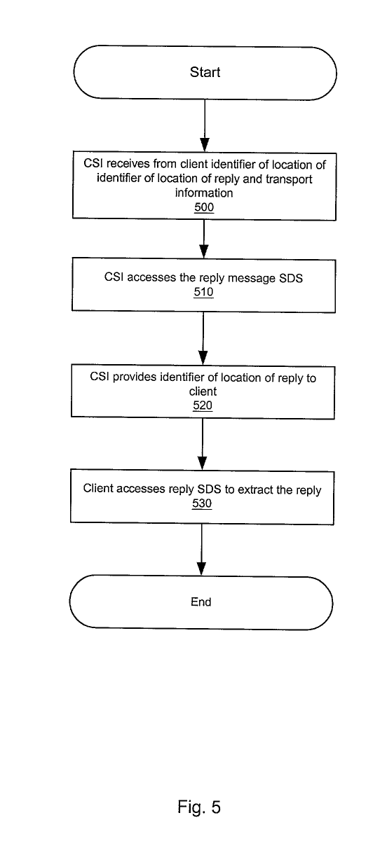

FIG. 5 is a flow diagram illustrating one embodiment of a client using a channel to receive a reply from a server. At 500, the CSI receives from the client the reply message SDS token. At 510, the CSI accesses the reply message SDS. At 520, the CSI transmits the reply SDS token to the client. At 530, the client accesses the reply SDS in order to extract the reply.

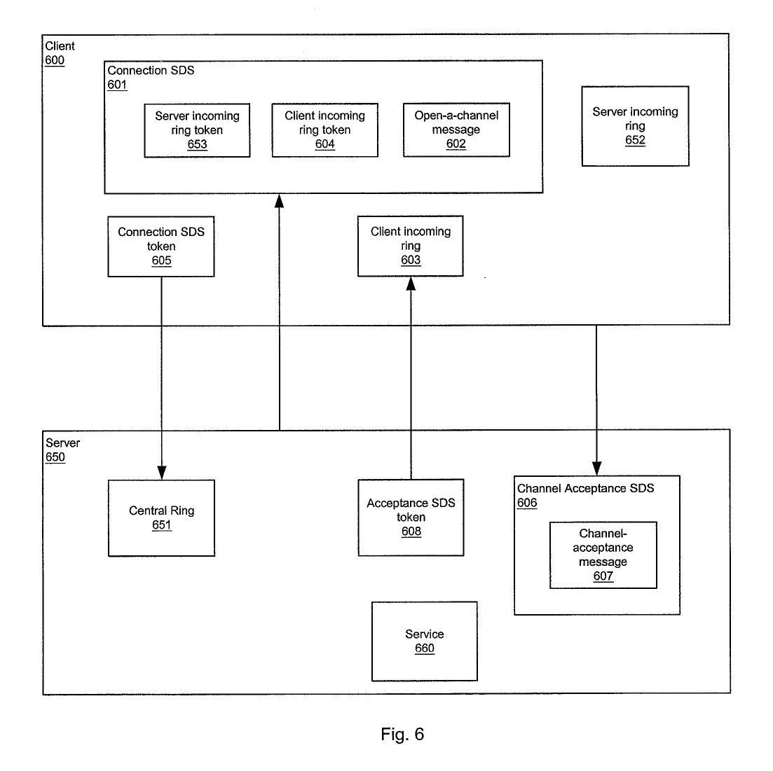

FIG. 6 is a block diagram of a client establishing a channel between the client and a server. Client 600 requires information from service 660 performing tasks as part of server 650, which contains central ring 651. Client 600 allocates a connection SDS 601 and records open-a-channel message 602 into connection SDS 601. Client 600 allocates server incoming ring 652 and receives server incoming-ring token 653 for server incoming ring 652. Client 600 obtains client incoming ring 603 and receives client incoming-ring token 604 for client incoming ring 603. Client 600 stores server incoming-ring token 653 and client incoming-ring token 604 in connection SDS 601, and transmits connection-SDS token 605 to central ring 651.

Server 650 receives connection-SDS token 605 on central ring 651. Server accesses connection SDS 601 and reviews open-a-channel message 602. Server 650 extracts server incoming-ring token 653 and client incoming-ring token 604 from connection SDS 601. Server 650 allocates channel acceptance SDS 606 and records channel-acceptance message 607 to channel acceptance SDS 606. Server 650 transmits acceptance SDS token 608 to client incoming ring 603. Client 600 retrieves acceptance SDS token 608 from client incoming ring 603. Client 600 accesses acceptance SDS 606 and reviews channel-acceptance message 607. Client 600 and server 650 establish their respective components of the channel.

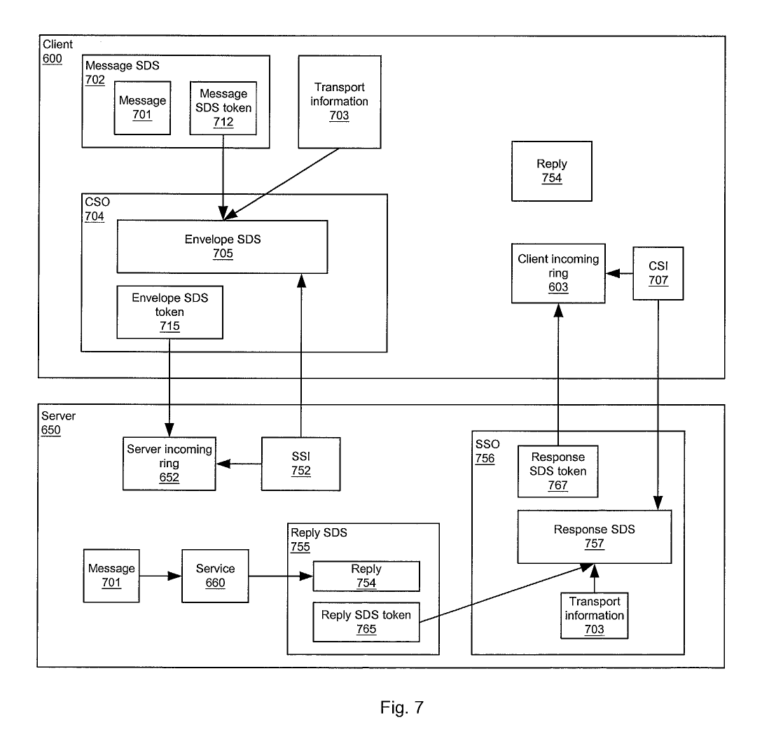

FIG. 7 is a block diagram of a client using a channel to transmit a message to a server. A component in this FIG. 7 previously described in another figure corresponds to the previously described component in the other figure. Client 600 allocates message SDS 702 and records a message 701 in a message SDS 702. Client 700 transmits message-SDS token 712 for message SDS 702, along with transport information 703, to CSO 704. CSO 704 allocates envelope SDS 705 and stores transport information 703 and message-SDS token 712 in envelope SDS 705.

CSO 704 transmits envelope-SDS token 715 for envelope SDS 705 to server incoming ring 652. Server 750 retrieves envelope-SDS token 715 from server incoming ring 652 and transmits envelope-SDS token 715 to SSI 752. SSI 752 accesses envelope SDS 705 and extracts transport information 703 from envelope SDS 705. SSI 752 provides transport information 703 to server 650, which stores transport information 703.

SSI 752 extracts message-SDS token 712 from envelope SDS 705, and provides message-SDS token 712 to server 650. Server 650 accesses message SDS 702 and extracts message 701 from message SDS 702. Server 650 provides message 701 to service 660.

Service 660 generates reply 754. Server 650 retrieves reply 754 and allocates reply SDS 755. Server 650 packages reply 754 in reply SDS 755, and provides reply SDS token 765 to SSO 756. Server 650 also retrieves transport information 703 and provides transport information 703 to SSO 756.

SSO 756 creates response SDS 757, and stores transport information 703 and reply-SDS token 765 in response SDS 757. SSO 756 then transmits response-SDS token 767 to client incoming ring 603.

Client 600 retrieves response-SDS token 767 from client incoming ring 603 and provides response-SDS token 767 to CSI 707. CSI 707 accesses response SDS 757 and extracts reply-SDS token 765 from response SDS 757. CSI 707 provides reply-SDS token 765 to client 600. Client 600 extracts reply 754 from reply SDS 755.

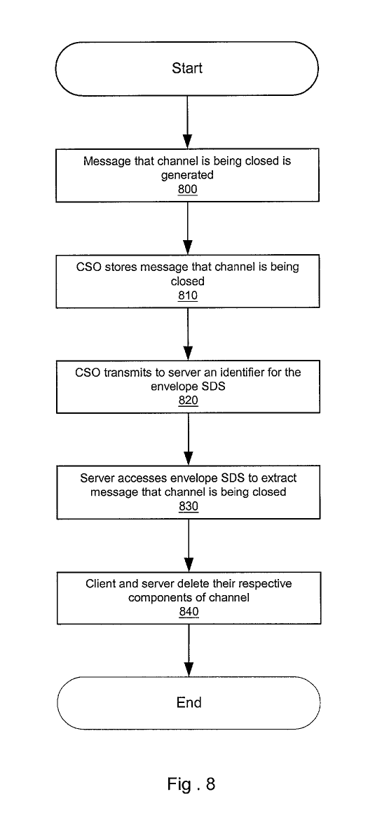

FIG. 8 is a flow diagram illustrating one embodiment of closing a channel. At 800, a message that the channel is being closing is generated. In one embodiment, the CSO generates the message as a result of an indication that the client is no longer using the channel. In an alternative embodiment, the client generates the message that the channel is being closed.

At 810, the CSO stores the message that the channel is being closed. In one embodiment, the CSO allocates an envelope SDS and stores the message in the envelope SDS. At 820, the CSO transmits to the server an identifier for the envelope SDS. In one embodiment, the CSO transmits an envelope SDS token to the server incoming ring. At 830, the server accesses the envelope SDS in order to extract the message that the channel is being closed. At 840, the client and the server delete their respective components of the channel. That is, the client deletes the CSO and the CSI, and the server deletes the SSO and the SSI.

In an alternative embodiment, once the server extracts the message that the channel is being closed, a determination is made whether the channel will be closed. When the channel is to be closed, the server stores an acknowledgement to close the channel. The server transmits to the client an identifier of the location of the acknowledgement. The client accesses the location of the acknowledgement, and the client and the server delete their respective components of the channel. However, when the channel will not be closed, the server stores a denial to closing the channel. The server transmits to the client an identifier of the location of the denial. The client accesses the location of the denial, and the channel remains open.

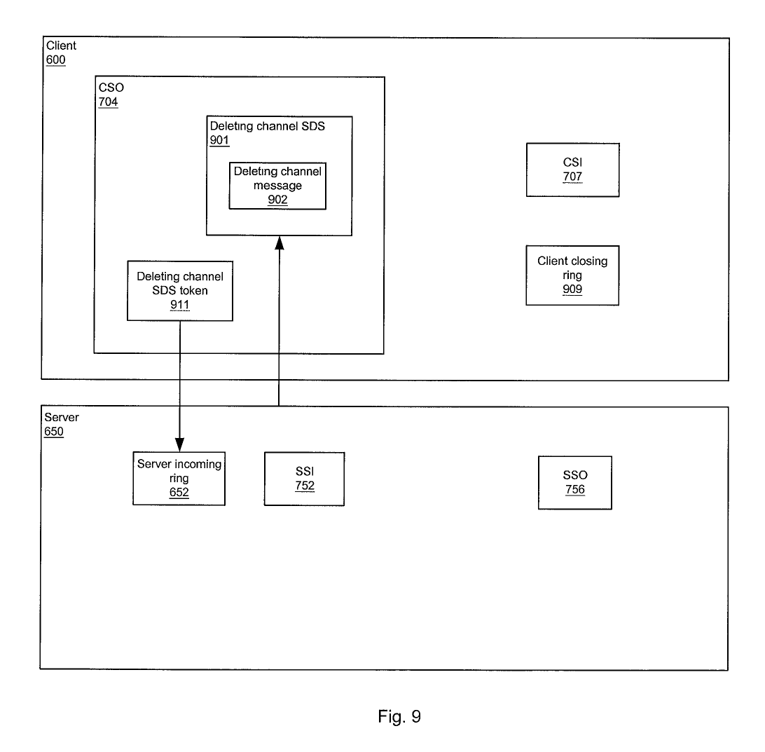

FIG. 9 is a block diagram of a client closing a channel. A component in this FIG. 9 previously described in another figure corresponds to the previously described component in the other figure. Client 600 transmits to CSO 704 indication 900 that client 600 will no longer use the channel consisting of CSO 704, CSI 707, SSI 752, and SSO 756. As a result, CSO 704 allocates deleting channel SDS 901, and records deleting channel message 902 into deleting channel SDS 901.

CSO 704 transmits deleting channel SDS token 911 to server incoming ring 652. Server 650 retrieves deleting channel SDS token 911 from server incoming ring 652. Server 650 accesses deleting channel SDS 901 in order to review deleting channel message 902. As a result, client 600 and server 650 delete their respective components of the channel.

For purposes of illustration and ease of explanation, the Figures herein have been described in specific terms of serialized data streams, rings and tokens. In alternative embodiments, other storage locations, data deposit locations and identifiers, respectively, can be used.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method comprising:
receiving from a first entity transport information and an identifier of a memory location of a message to a second entity;
storing in a different memory location the transport information and the identifier of the memory location of the message; and
transmitting to the second entity based on the transport information a different identifier of the different memory location.

2. The method of claim 1, further comprising:
receiving the different identifier of the different memory location from the second entity;
retrieving from the different memory location the identifier of the memory location of the message; and
providing the identifier of the memory location of the message to the second entity.

3. The method of claim 2, wherein the first entity comprises a client software application.

4. The method of claim 3, wherein the second entity comprises a server software application.

5. The method of claim 4, wherein the memory location comprises a serialized data stream (SDS) and the different memory location comprises a different SDS.

6. The method of claim 5, wherein the identifier comprises a token and the different identifier comprises a different token.

7. A method comprising:
storing by a client a message in a message serialized data stream (SDS);
receiving by a first component of a channel from the client transport information and a token for the message SDS;
packaging by the first component of the channel the message SDS token and the transport information in an envelope SDS; and
transmitting by the first component of the channel an envelope SDS token to a server based on the transport information.

8. The method of claim 7, further comprising:
receiving by a second component of the channel from the server the envelope SDS token;
extracting by the second component of the channel the transport information from the envelope SDS;
providing by the second component of the channel the transport information to the server; extracting by the second component of the channel the message SDS token from the envelope SDS; and
providing by the second component of the channel the message SDS token to the server.

9. The method of claim 8, further comprising:
extracting by the server the message from the message SDS;
providing by the server the message to a service;
providing by the service a reply to the message; and
packaging by the server the reply in a reply SDS.

10. The method of claim 9, further comprising:
receiving by a third component of the channel from the server a reply SDS token;
receiving by the third component of the channel from the server the transport information;
packaging by the third component of the channel the reply SDS token and the transport information in a response SDS; and
transmitting by the third component of the channel a response SDS token to the client based on the transport information.

11. The method of claim 10, further comprising:
receiving by a fourth component of the channel from the client the response SDS token;
retrieving by the fourth component of the channel the reply SDS token from the response SDS;
providing by the fourth component of the channel the reply SDS token to the client, which extracts the reply from the reply SDS.

12. An article of manufacture comprising:
a machine-accessible medium including thereon sequences of instructions that, when executed, cause an electronic system to:
receive from a first entity transport information and an identifier of a memory location of a message to a second entity;
store in a different memory location the transport information and the identifier of the memory location of the message; and
transmit to the second entity based on the transport information a different identifier of the different memory location.

13. The article of manufacture of claim 12, wherein the machine-accessible medium further comprises sequences of instructions that, when executed, cause the electronic system to:
receive the different identifier of the different memory location from the second entity;
retrieve from the different memory location the identifier of the memory location of the message; and
provide the identifier of the memory location of the message to the second entity.

14. The article of manufacture of claim 13, wherein the sequences of instructions that, when executed, cause the electronic system to receive from the first entity the transport information and the identifier of the memory location of the message to the second entity comprise sequences of instructions that, when executed, cause the electronic system to receive from a client software application the transport information and the identifier of the memory location of the message to the second entity.

15. The article of manufacture of claim 14, wherein the sequences of instructions that, when executed, cause the electronic system to receive from the first entity the transport information and the identifier of the memory location of the message to the second entity comprise sequences of instructions that, when executed, cause the electronic system to receive from the first entity the transport information and the identifier of the memory location of the message to a server software application.

16. The article of manufacture of claim 15, wherein the sequences of instructions that, when executed, cause the electronic system to receive from the first entity the transport information and the identifier of the memory location of the message to the second entity comprise sequences of instructions that, when executed, cause the electronic system to receive from the first entity the transport information and the identifier of a serialized data stream (SDS) to the second entity.

17. The article of manufacture of claim 16, wherein the sequences of instructions that, when executed, cause the electronic system to store in the different memory location the transport information and the identifier of the memory location of the message comprise sequences of instructions that, when executed, cause the electronic system to store in a different SDS the transport information and the identifier of the memory location of the message.

18. The article of manufacture of claim 17, wherein the sequences of instructions that, when executed, cause the electronic system to receive from the first entity the transport information and the identifier of the memory location of the message to the second entity comprise sequences of instructions that, when executed, cause the electronic system to receive from the first entity the transport information and a token of the memory location of the message to the second entity.

19. The article of manufacture of claim 18, wherein the sequences of instructions that, when executed, cause the electronic system to transmit to the second entity based on the transport information the different identifier of the different memory location comprise sequences of instructions that, when executed, cause the electronic system to transmit to the second entity based on the transport information a different token of the different memory location.

20. An apparatus comprising:
a client side outgoing channel component that receives from a client transport information and a message SDS token of a message SDS, packages the message SDS token and the transport information in an envelope SDS and transports an envelope SDS token to a server;
a server side incoming channel component that receives the envelope SDS from the server, extracts the message SDS token from the envelope SDS and provides the message SDS token to the server;
a server side outgoing channel component that receives from the server a reply SDS token of a reply SDS containing a reply to the message, stores the reply SDS token in a response SDS and transports a response SDS token to the client; and
a client side incoming channel component that receives from the client the response SDS token, extracts the reply SDS token from the response SDS and provides the reply SDS token to the client.

21. The apparatus of claim 20, wherein the server side incoming channel component extracts the transport information from the envelope SDS and provides the transport information to the server.

22. The apparatus of claim 21, wherein the message SDS contains a message from the client requesting information from a service performing tasks as part of the server.
